(19) United States
(12) Patent Application Publication
(10) Pub. No.: US 2002/0031753 A1
(43) Pub. Date: Mar. 14, 2002

(54) Instructional method for sports, hobbies, amusements and for activities in the daily environment, etc.

(76) Inventors: Shigeo Yanai, Tokyo (JP); Muneomi Katayama, Tokyo (JP)

Correspondence Address: REED SMITH HAZEL & THOMAS LLP, Suite 1400, 3110 Fairview Park Drive, Falls Church, VA, 22042, US

(21) Appl. No.: 09/848,367

(22) Filed: May 4, 2001

(30) Foreign Application Priority Data
Jun. 28, 2000 (JP) 2000-195341

(51) Int. Cl. G09B 9/00; A63B 69/00

(52) U.S. Cl. 434/247

(57) ABSTRACT

It is made possible wherein, concerning problem points in regard to which a learner would like improvement, at the time that such are compared with those of an instructor, the model performance of the instructor can be precisely accessed as images. Moreover, it is made possible wherein the above described model performance of the instructor can be displayed in diagrammatic representation and/or letters or speech sound.

An electronic apparatus such as a DVD, the Internet, a PC, etc., is used as a means of recording, editing, processing through operations and searching the data of the examples of problem points and methods for improvement.

### DETAILED DESCRIPTION OF THE INVENTION

### Field of Industrial Application

The present invention is a method for the improvement of the instruction of individual sports, as represented by golf, tennis etc., team sports, as represented by baseball, soccer etc., outdoor sports, as represented by skiing, skating, etc., sports where an object is pursued, as represented by fishing, hunting, etc., as well as hobby games, such as go, chess etc., amusements, various types of medical treatments, beauty treatments, etc., and activities in the daily environment.

### Prior Art

Hitherto, in the instruction of these types of sports, hobbies, amusements, etc. and other activities in the daily environment an instructor would perform a model performance and, subsequently, would have the learner perform the action and, then would explain, verbally or physically, the difference between the two.

### PROBLEM TO BE SOLVED BY THE PRESENT INVENTION

But, as is known by U.S. Pat. No. 5,184,295, the instructional method is in widespread usage wherein an instructor's model performance is inputted, in advance, to a VTR and those images, as well as the images of the performance of the learner, are processed through operations and overlapped in a three dimensional manner.

Furthermore, one of the inventors of the present invention, Muneomi Katayama, has improved upon this invention, and been granted U.S. Pat. No. 5,857,855, wherein the model performance of the instructor and the performance of the learner are played back without overlapping on the same screen and, by thereby comparing and contrasting those two images, the differences between the two can be made clear to the learner.

However, it is normal for a learner to want to use the instructor's model performance concerning the performance of “one specific point.” Taking golf as a concrete example, it is natural to imagine that if it is a case where “you usually hit slices with your driver,” the manner of gripping the club is probably bad and one would like to get immediate advice on that point or if it is a case where “you can't hit the ball out of the bunker,” the learner would like to observe the performance of the instructor in regard to the placement of the face of the sand wedge. This point is common to the field of the aforementioned sports, hobbies and amusements.

Accordingly, the purpose of the present invention is, in the case that a learner wants to overcome and correct a problem point by comparison with the instructor, to enable instant access to images of the model performance of the instructor.

In general, the purpose of the present invention is to enable the above described model performance of the instructor to be displayed by diagrammatic and/or letters and by speech sound.

### MEANS FOR SOLVING THE PROBLEM BY THE INVENTION

The present invention is characterized in that main heading sections as well as subheading sections, containing problem points that learners are liable to, are created and, by clicking these, the problem point that the learner has as well as a concrete example of an overcoming of that problem point together with the method for making the improvement are made to be displayed in diagrammatic representation and/or letters and by speech sound, etc.

The present invention is characterized in that, by using a DVD (digital video disc) system, Internet system or computer system, etc., as a means of recording, editing, processing through operations and searching the data of the above described examples of individual problem points as well as methods for improvement, that system can be easily used and, furthermore, concrete examples of problem points and methods for overcoming those problems can be instantly displayed.

The present invention is characterized in that, concerning the diagrammatic representation of the above described examples of individual problem points and methods for improvement, when the learner looks at the display of the overlapping lines or grid lines, which make up the criteria, upon that diagrammatic representation, the learner can be made to understand the proper method for improvement.

The present invention is characterized in that, as for the problem points of the above described examples of individual problem points and methods for improvement, the images of the learner and of the instructor are not overlapped when displayed and when the respective differences of those images are compared and contrasted the learner can be made to understand the problem. The present invention is characterized in that, the images of the above described examples of individual problem points and methods for improvement are displayed as moving images and/or still images are displayed without the overlapping of the learner's and the instructor's images and when the respective differences of those images are compared and contrasted the learner can be made to understand the problem.

The present invention is characterized in that, the images of the above described examples of individual problem points and methods for improvement are able to be recorded on a recording medium, including paper, and can later, by serving as a reference, enable the learner to understand his improvement.

The present invention is characterized in that, as for the above described problem points pertaining to individual sports, as represented by golf, fishing, tennis, table tennis, etc., by clicking the problem points that the learner wants to improve upon, a concrete example of the problem point that the learner has as well as a method for making improvement are displayed by means of diagrammatic representation and/or letters, speech sound, etc. The present invention is characterized in that, as for the above described examples of problem points pertaining to team sports, as represented by baseball, soccer, basketball, etc., by clicking the problem points that the learner wants to improve upon, a concrete example of the problem point that the learner has as well as a method for making improvement are displayed by means of diagrammatic representation and/or letters, speech sound, etc. The present invention is characterized in that, as for the above described examples of problem points pertaining to combative sports, as represented by sumo, wrestling, judo, boxing, etc., by clicking the problem points that the learner wants to improve upon, a concrete example of the problem point that the learner has as well as a method for making improvement are displayed by means of diagrammatic representation and/or letters, speech sound, etc.

The present invention is characterized in that, as for the above described examples of problem points pertaining to outdoor sports, as represented by surfing, skiing, skating, swimming etc., by clicking the problem points that the learner wants to improve upon, a concrete example of the problem point that the learner has as well as a method for making improvement are displayed by means of diagrammatic representation and/or letters, speech sound, etc.

The present invention is characterized in that, as for the above described examples of problem points pertaining to sports where an object is pursued, as represented by fishing, hunting etc., by clicking the problem points that the learner wants to improve upon, a concrete example of the problem point that the learner has as well as a method for making improvement are displayed by means of diagrammatic representation and/or letters, speech sound, etc.

The present invention is characterized in that, as for the above described examples of problem points pertaining to hobby games and amusements, as represented by go, chess, shogi, dance, billiards, etc., by clicking the problem points that the learner wants to improve upon, a concrete example of the problem point that the learner has as well as a method for making improvement are displayed by means of diagrammatic representation and/or letters, speech sound, etc.

The present invention is characterized in that, as for the above described examples of problem points pertaining to activities in the daily environment, as represented by various types of medical treatments, beauty treatments, weight training, flower arrangement, floral art, cooking, etc., by clicking the problem points that the learner wants to improve upon, a concrete example of the problem point that the learner has as well as a method for making improvement are displayed by means of diagrammatic representation and/or letters, speech sound, etc.

### EMBODIMENTS OF APPARATUSES AND A SYSTEM UTILIZED IN THE PRESENT INVENTION

First, in order to explain an embodiment of the present invention, an example of the composition of the apparatuses used will be explained.

In FIG. 1, (A) is a recording medium, including paper, (B) is an ordinary DVD player etc., the Internet etc., a personal computer, etc., information transmission apparatus or system. And (C) is image data containing images of the instructor showing the proper form of an instructor and the problem points of the learner, wherein magnification and reduction means (D) of that data and a two screen display means (E) as well as data such as letters and diagrams inputted by the instructor are added and recorded so that the data that is required by the learners is instantly displayed (F) by clicking the necessary data.

And (G) is a system wherein the instructor inputs, to the image of the learner or the instructor, appropriate advice in letters or in a diagram (H) as well as to a speech sound system (J).

### Embodiment 1

One embodiment of the present invention is given of an individual sport, as represented by golf.

In FIG. 2, as for (1), the main heading section (I) of the layout of various types of electronic apparatuses is made up of the start menu for golf, that is to say, of basic examples of problem points, wherein are displayed five menus which are basic unit (11), practice unit (12), clinic (13), drill (14) and image swing (15).

Next, when the various items of this heading section (I) are clicked, each of the subheading sections (II) are displayed. That is to say, if the above described basic unit (11) is clicked, the manner of gripping the club (111), the position to take a swing (112), the swing axis (113), backswing and topswing (114), downswing and finish (115), orbit of clubface (116), ball position and setting of objective (117), harmonization of swing (118), etc., and menus containing more detailed items, in addition to basic items used in golf, are displayed.

Next, when practice unit (12) is clicked, as shown in the figure, the actual scenery of a golf course is represented and the letters for putting (121), bunker (122), approach (123), trouble shot (124), fairway (125), tee (126) are displayed. Furthermore, in this embodiment when putting (121) is clicked, putting basics (1211), putting practice (1212) are thus displayed.

In the same manner, when bunker (122) is clicked the three items of basics of bunker shots (1221), judging distance in bunker shots (1222), bunker shots according to different situations (1223) are displayed and when approach (123) is clicked the three items of pitch shot (1231), chip shot (1232), approaches according to different situations (1233) are displayed.

Continuing, when trouble shot (124) is clicked, hitting out of the rough (1241), bunkers on the fairway (1242), hitting on an incline (1243), hitting from a bad lie (1244) are displayed, when fairway (125) is clicked, basics of woods for the fairway (1251), basics of irons (1252), hitting from a slanted surface (1253) are displayed and when tee (126) is clicked, basics of tee shots (1261) and game management (1262) are displayed.

Of course, the menu items are not limited to these and they can be changed to be appropriate for professional, amateurs, according to differences in handicaps and other learner conditions. The present inventor at present has, in fact, classified examples of problem points into 70 categories and, to deal with them, has 420 instructional methods and operational steps, which can be called prescriptions.

And, the main instructional drill consists of a 22 course program, made up of images of the demonstration of model swings by a professional, speech sound comments (words) and music.

And, these menus, besides on a DVD system, can be used by accessing the Internet (the Internet (JGN), Jupiter Golf Net (CA station=JGN)), but, here, an example using a DVD system is explained.

Now, when the learner sets the above described DVD disc in the DVD player, the main heading section (A), containing the examples of basic problem points, is automatically displayed.

Here, the learner, in accordance with his/her problem point, when it is thought that there is a problem at the basic item of the manner of gripping the club, that is to say, grip technique, clicks basic unit (I). After that, 8 subheading sections (II) are instantly displayed so if the manner of gripping the club (111) is clicked, as is shown in FIG. 3, the images of the instructor are displayed and, at the same time, the manner of gripping the club is expressed via speech sound.

Accordingly, the learner compares this image to the manner of gripping that the learner has been using up to the present and it would be proper to correct the manner of gripping but, as the same diagram shows, when the learner grips the club by making the fundamental lines (X) the proper manner of gripping becomes even more clear.

And, as for a basic movement of the learner, when it is desired to be known what position is the top position of a tee shot or in the case where the overall flow of the tee shot is desired to be grasped, when the image swing (15) of the main heading section (I) and, further, the backswing and topswing (114) of the subheading section (II), which has been displayed accord to this, is clicked then, as in FIG. 4, two swing screens, that is to say, with the right side showing the form that the learner is prone to fall into and the left side showing the proper form of the instructor, are shown without overlap and, moreover, there is an explanation in speech sound so that the learner can easily discover his problem points and can easily do corrective practice for problem points and the results can be easily retained. Concretely, when backswing and topswing (114) has been clicked, as in FIG. 4, the file of the front image of the instructor's address to the ball is displayed and the line linking the player's shoulder with the club head, etc., the line linking the head of the player's club and a figure (photograph) guiding that angle to the proper angle as well as the important parts expressed in lines are displayed in order to make the learner understand quickly.

Further, at this time, as for the line that links the left shoulder of the above described player with the club head, the line which has moved downward at that time, as it is, in parallel to the player's grip at the time that the club comes to the position of the club top and the learner is, thereby, taught that it is important that there be an applicable club between the respective lines and the learner can easily understand this.

Furthermore, as for one of the images of FIG. 4, if the DVD system in this case is a so-called “DVD disc,” etc., which can be written into, it is, of course, desirable to enter those same above described learner's images.

And, there is also the case wherein the learners themselves are not aware of their own problem points and wherein they cannot comprehend where the problem is with their form. In this case, a prescription, in question form, can be prepared and, by clicking the so-called (HELP) button of the keyboard it can be displayed.

That is to say, it is done as in FIG. 5, where there is a title “Welcome to the golf swing analysis and lesson system,” etc., and ‘Please click the below course according to your concerns and questions concerning your golf game.’

Next, this prescription will ask, by being made to be clicked, whether the concern is “driving range (practice area) course” or “practice round course.” Then, in the case that it is ‘driving range (practice area) course,’ “instant lesson according to club” and “steadily building a swing with the 6 iron (basic club)” are displayed.

Here, when ‘instant lesson according to club’ is clicked, driver (tee up wood shot), basic iron (5 to 7 iron), fairway wood shot (wood shot without tee up), short iron (8 to 9 iron), long iron (2 to 4 iron) and wedge are displayed.

Next, in the case that the learner is worried about his driver swing, “driver” is clicked and, as for basic knowledge about driving, ‘What kind of club is the driver?,’ etc., and as for missed shots, ‘What is the tendency of your driver errors?,’ are displayed in letters. In the case where a plurality of error tendencies are confirmed, errors are to be viewed in order starting from higher error frequency items. In other words, that problem point menu displays concrete areas of worry such as ‘slice,’ ‘duffed ball, popped up ball,’ ‘ball doesn't rise,’ ‘hook,’ ‘topped ball,’ ‘ball rises too high,’ etc., and when this is clicked a diagrammatic representation is chosen and displayed from the driver shot (151) of the aforementioned image swing (15). Next, when practice unit (12) is clicked, the letters putting (121), bunker (122), approach (123), trouble shot (124), fairway (125) and tee (126) are displayed on the representation of the actual scenery of a golf course.

Furthermore, in this embodiment, when putting (121) is clicked, basics of putting (1211) and putting practice (1212) are displayed. In the same manner, when bunker (122) is clicked, the three items of basics of bunker shots (1221), judging distance in bunker shots (1222) and bunker shots for various situations (1223) are displayed and when approach (123) is clicked, the three items of pitch shot (1231), chip shot (1232) and approach shots for various situations are displayed.

Continuing, when trouble shot (124) is clicked, hitting to the rough (1241), fairway bunkers (1242), hitting on a slant (1243), hitting out of bad lies (1244) are displayed and when fairway (125) is clicked, basics of woods on the fairway (1251), basics of irons (1252), hitting on inclines (1252) are displayed and when tee (126) is clicked, tee shot (1261) and game management (1262) are displayed.

### Embodiment 2

Next, taking the team sport of baseball as an example, in FIG. 6 five menus are displayed in the heading section (III), in the same manner as in the previous embodiment.

That is to say, these are basic unit (21), practice unit (22), clinic (23), drill (24) and image swing (25) and, here, when the basic unit (21) is clicked, how to grip the ball (211), position for throwing (212), throwing form (backswing finish) (213), position for catching the ball (214), movements of catching (catching) (215), how to hold the bat (216), swinging position (217), movements of swinging (backswing finish) (218), base running position (219), movements of base running (running) (210) are displayed.

Next, in the case that the practice unit (22) is clicked, as is shown, on the practice side, as is shown in FIG. 6, as for the defensive side, outfielders (221), infielders (222) pitcher (223), catcher (224) and, as for the offensive side, runners (224) and batter (225) on a diamond (IV) are displayed.

Here, when outfielder (221) is clicked, left field defense (2211), center field defense (2212), right field defense (2213), how to go after fly balls and throw the ball in (2214) and how to go after ground balls and throw the ball in (2215) are displayed. Continuing, infielder (222) consists of first baseman defense (2221), second baseman defense (2222), third baseman defense (2223), shortstop defense (2224), preventing stolen bases bases loaded defense (2225), defense of bunts•double plays (2226), and when pitcher (223) is clicked, defense of bunts (2231), base covering (2232) and throwing the ball to keep the runner on base (2233) are displayed.

In the same manner, runner (224) consists of displays of running from first base (2241), running from second base (2242), running from third base (touching up) (2243) and sliding (2244) and hitter (225) consists of displays of hitting curve balls (2251), hitting inside corner pitches (2252), hitting outside corner pitches (2253), bunting (2254) and running to first base (2255).

And, catcher (226) consists of displays of basics of catching (2261), defense for catchers (fly balls•ground balls•base covering) (2262), basics of guarding home base (2263), throwing to prevent the runner from advancing to the next base (2264) and how to give signs (2265). When the clinic (23) menu of heading section (III) is selected, can't throw the ball straight (231), can't throw a curve ball (232), can't catch a fly ball (233), can't catch a ground ball (234), can't swing the bat properly (235), can't slide (236) are displayed and, in the same manner, as for the menu of drill (24), changing the grip on the ball (241), learning how to catch the ball (242), frontally facing and catching the ball (243), different ways of holding the bat (244) and sliding practice (245) are displayed.

As for the menu of image skills (25), pitching (overhand throw) (251), pitching (side arm throw) (252), pitching (underhand throw) (253), fielding of catchers (catching and throwing the ball) (254), fielding of infielders (catching and throwing the ball) (255), fielding of outfielders (catching and throwing the ball) (256), batting (257), bunting (258) and running (base running) (259) are displayed. Then, when batting a learner may be worried about not being able to cope with curve balls, wherein the ball may not be making contact with the so-called sweet spot of the bat, resulting in frequent ‘foul balls.’ Accordingly, in order to solve that problem, the practice unit (22) of the heading section (III) is clicked and then the hitter (225) of the displayed sub heading section (IV) is clicked.

After that, inside curve ball (2251) of hitter, which has been displayed on the layout, is clicked and a diagrammatic representation as in FIG. 7 is displayed. In this case, the left side is the instructor's batting form and the right side is the form that the learner is likely to fall into and it can be understood that this fault will likely result in foul balls, etc., because the wrists are in front of the batting position when batting.

Several types of this type of form are normally prepared and the learner can choose the form that most closely approximates the form thereto and, by comparing and contrasting their own form and the instructor's form, they can make improvements.

At this time, naturally, advice is given by means of speech sound, such as that the grip of the right hand is so-called ‘loose,’ etc., or that the stance is being opened up too quickly. Furthermore, as a matter of course, if this DVD is of a type that can be written into, one can, for example, photograph with a digital camera and display their own (learner) applicable form together with that of the instructor and thereby make their own problem points even more evident.

### Embodiment 3

Judo will be given as an embodiment of a combative sport. Learners who are presently having trouble with, and want to correct, their ‘form’ insert the judo (DVD) into the reader and a heading section (V) will first be displayed, as shown in FIG. 8. Then, of that heading section (V), basic unit (31), practice unit (32), clinic (33), drill (34) and image skill (35) are displayed. Here, in the case that the basic unit (31) menu is clicked, the eight menus, etiquette (standing bow•bow) (311), holds (right cross grip•left cross grip•opposing grip) (312), basics of kuzushi (happo kuzushi=eight direction balance loss) (313), walking method (footwork by sliding the feet, tsugiashi footwork) (314), body turning (315), falling (316), throwing techniques (317) and grappling techniques (318) are displayed.

Further, the practice unit (32) menu consists of the menus of, standing techniques of throwing techniques (321), sacrifice techniques (322), hold-down techniques of grappling techniques (323), choke holds (prohibited for elementary school age and below) (324) and joint locking techniques (prohibited for junior high school students and below) (325).

Among these, the menu of standing techniques of throwing techniques (321) contains, basic movements of body turning and falling (3211), for example, mastering the hand techniques of one-arm shoulder throw, knockdown, etc., (3212), for example, mastering hip techniques such as the sweeping hip throw, lifting pulling hip, etc., (3213), mastering leg techniques such as major outer reaping, inner thigh throw, etc., (3214), and, the throwing techniques such as sacrifice techniques (322) menu contains, basic movements of body turning and falling (3221) and mastering the giving and receiving of circle throws (3222).

Next, the grappling techniques of hold-down techniques (322) contains, for example, collar hold, how to enter the side locking four corner hold hold-down technique, etc. (3231), continuation techniques from throwing techniques to hold-down techniques (3232), how to execute upper body movements and how to execute leg pulls (3233) and attacks from below (3234).

Furthermore, as for grappling techniques (choke holds) (324), prohibited outside of the head area (3241), basic movements of choke holds (both arms grabbing opponent's collar (3242) and mastering choke holds (sliding collar choke cross choke) (3243), and as for grappling (joint locking techniques) (325), choke holds prohibited outside of the elbow (3251), basic movements of choke holds (reverse extension of the elbow•twisting hold) (3252) and mastering choke holds (cross arm bar•arm wrap) (3253) are displayed.

As for the click (33) menu of the heading section (V), from the subheading section (VI) the three menus, cannot perform falls (331), difficulty learning footwork (332) and difficulty learning throwing techniques (333) are displayed.

Similarly, as for the drill (34) menu, mastering proper falls by repeated practice (341), repetition of sliding footwork without lifting feet off of the tatami mat (342), using walls and pillars to practice techniques (343), practicing with partners of the same body type (weight) (344) and mastering how to apply techniques•how do falls in free practice (345) are displayed.

As for the above mentioned image skill (35) menu, one-arm throw throwing technique (351), shoulder throw (352), knockdown (353), shoulder wheel (354), major hip throw (355), sweeping hip throw (356), lifting pulling hip (357), major outer reaping (358), double ankle sweep (359), knee wheel (360), major inner reaping (361), minor inner reap (362), lifting pulling ankle block (363), minor outside reap (364), advancing foot sweep (365), inner thigh throw (366), lifting pulling foot sweep (367), minor outside hook (368), circle throw (369), back throw (370), collar hold (371), variation collar hold (372), upper four corners (373), side four corners (374), straight locking four corners (375), choke holds (prohibited for elementary school age and below) (376) and joint locking techniques (prohibited for junior high school students and below) (377) are displayed.

Then, there may be the case where a learner is worried that they cannot perform a one-arm shoulder throw. Accordingly, when the image skill (25) menu of the heading section is clicked and, continuing, when ‘throwing technique, one-arm shoulder throw’ (351) is clicked, FIG. 9, for example, is displayed on the layout and, at the same time, either by ‘speech sound’ or by letters, the advice is given that ‘Unless the one-arm throw is used as part of a two technique combination it will not be effective. Are you performing a one-arm throw only?,’ etc.

In other words, an explanation is given such as, first apply a minor inner reap to your opponent and, then, your opponent will bring his right leg far back in order to prevent this. Here, as the opponent stumbles and attempts to regain their balance, at the moment that the right leg is brought forward, by executing a right leg front-turn movement control a one-arm shoulder throw should be performed, etc.

On the other hand, as for the practice method for shoulder throws, it is appropriate for three players to practice without throwing each other (practice) as in FIG. 9. In the figure, the instructor is on the left and the position that the learner is likely to fall into is on the right. In other words, this practice without throwing aids in the building up of the muscles needed to perform shoulder techniques and, here, the attacking player performs the action to try to throw the opponent but his/her form is incorrect and a third participant (assistant) helps to reset the posture into the proper position. Such additional advice follows the above described explanation or the ‘HELP’ button may be clicked in order to gain such a display.

### Embodiment 4

Skiing will be given as an example of an outdoor sport. Here, there is the heading section, which is not specifically graphically represented, containing the five menus of, [1] basic knowledge, [2] beginning techniques, [3] basic techniques, [4] accomplished techniques and [5] practice techniques and below, moreover, the details of menus are omitted with only parts introduced.

That is to say, as for the basic knowledge subheading section there is ‘What is skiing?’ and, as for the beginning techniques subheading section, there are the nine menus, before starting to ski, first start with walking, putting on both skis, stopping, skiing, turning techniques, beginning descent, moving forward and horizontally and general descent.

As for basic knowledge, there are provided, the objective of skiing and the method of practice, and the what equipment is necessary for skiing? and prevention of injury and health maintenance menus and, as for techniques, walking on one leg, skiing on one leg, changing direction using one leg and, continuing, as for the basic techniques subheading section there are, from rough to smooth, parallel by alternating steps in parallel as well as three other items and, as for the subheading section of accomplished techniques there are the four items of, traverse, straight descent, parallel turn and wedeling and, as for the practice techniques heading section there are the four items of, skiing on moguls, skating, step turns and summary.

In practice techniques there are the menus of, putting on both skis, maintaining balance on level surfaces, changing direction with both legs, measuring increase in speed, how to fall and how to get up, changing directions and climbing up slopes and, as for stopping there are the detailed menus of, A frame, snow plow, shifting across the snow surface, pflugbogen and for ‘skiing’ there are the detailed menus of, straight descent, bending and extending of joints and jumps.

In addition, there are also the menu items for accomplished techniques of, traverse, straight descent, stop turns and parallel turns and, as for wedeling there are the menus of, mild slope, middle angle slope and steep slope. Furthermore, the ‘summary’ item is very important and it is essential that there is, in particular, an accomplishing objectives menu.

Presently, a learner is concerned that they cannot effectively shift their skis when turning. In this case, the above described traverse of accomplished techniques is clicked. As a result, on the screen, as shown in FIG. 10, two graphic representations are displayed without overlapping.

Together with this, at the same time, “Here, the important point is the movement of the knees. Now, the knees on the left side of FIG. 10 are making the edges of the skis slide but on the right side the knees are not making the edges slide. Therefore, you must position your knees according to the right image.,” etc., is provided using letters or speech sound, and lines or arrows are inserted into one side of the instructional image in order for the learner to easily understand.

### Embodiment 5

Fishing will be given as an example of a hobby. That is to say, an instructional DVD is inserted into the reader and the heading section menus containing, river fishing and ocean fishing, fishing spots and fishing techniques, fishing in mountain lakes and upstream fishing, lake and marsh fishing, midstream fishing and downstream fishing, downstream fishing and river mouth fishing, breakwater fishing and tidal lake fishing, ocean park fishing and sand beach fishing, seashore fishing and offshore fishing are displayed.

Then, presently, as for the river fishing submenu, there is the river fishing menu containing, mountain stream lures, floats, and small river fish and, as for basics of ocean fishing there are, breakwater fishing, seashore fishing and boat fishing. A detailed breakdown of the various menus will be omitted but, for example, in the above described ‘boat fishing’ it is important that there are menus of concrete enumerations of fish names, such as greenling, conger eel, white sillaginoid, goby, black rock fish, mackerel•horse mackerel, grunt, young yellowtail, red sea bream, flounder, flathead, etc., and guidance in techniques for catching them.

Now, suppose that there is a learner who goes out on a boat fishing for ‘white sillaginoid’ and, while others are getting so-called ‘bites,’ the learner is not getting any ‘bites.’ Thereupon, the above described ‘ocean fishing’ is clicked and images such as in FIG. 11 are produced.

Together with this, ‘There are many cases of ‘bites’ where the ‘bite’ cannot be felt. Isn't this the same in your case? In this case, when selecting a fishing rod, please use a rod with a flexible rod end.,’ etc., is displayed in speech sound, letters, etc.

Again, continuing, as in the three screens of FIG. 11, the methods differ for shallow areas and for deep areas (upper left) concerning the way of casting in deep areas (lower left), free play of the line (upper right), etc., tidal flows and the launching of boats, etc., and it is important that the instruction of the instructor is arranged such that such basic points are taught.

### Embodiment 6

As for an embodiment of the present invention in regard to the field of hobbies, speaking of go, in a basic heading section for an absolute ‘beginner’ of go, how to take go stones, life and death, ko, territory and eye, standard moves, reading, endgame and end of game are displayed.

Accordingly, when the above described ‘how to take go stones’ is clicked, the subheading menu containing, board edge stones, atari and nige, the role of the board edge, the board edge and connection, ladder, areas that cannot be played, and capture takes precedence. In the same manner, when ‘survival and death’ is clicked, the individual menus of, survival, method of survival, method of death, false eye, stone survival, and stone death are displayed.

Next, when ko is not understood, the above described ko is clicked and, rules of ko, resolution of ko, continuation of ko, ko relating to survival and death, ko and ko threat, board edge ko, and means to ko are displayed and the desired item may be clicked.

Further, the following menus are displayed: as for ‘standard moves’ there are beginning standard moves, intermediate standard moves, and advanced standard moves, as for ‘reading’ there are reading at open, reading in middle game and endgame reading, as for ‘territory and eye’ there are definition of territory, counting of territory, incomplete territory, and defects at board edge, as for ‘endgame and end of game’ there are definition of endgame, board edge endgame, increase and decrease at endgame, first stone endgame, okina endgame, neutral point, and end of game and game outcome.

Now, there is the case where a go fan (learner) is worried that in the middle game they are “poor at reading.” In this case, reading the middle game is clicked and images of the middle game situation, as in the left side of FIG. 12, are displayed. Here, the learner must consider their next ‘move’ but, in actuality, the next move can only be arrived at after considering several other possible moves. Further, the material shown in FIG. 12 is derived from the go instruction of Yoko Shinkai.

Here, the answer button (not shown) is clicked and the go chart of the right side of FIG. 1 and such speech sound and/or letters as, ‘black 10 should be blocked by 11. If it is desired that black 10 be blocked then black 8 should have been pincer attacked by A or B. White 13 is forced up by the distant pincer attack of black 8 and, here, is not stopped. Black 20 and, further, black 30 are also not possible. If black 20 is played it would be C and it can be said that it would be a move where black 30 would become useless,’ etc., are displayed.

Furthermore, in addition, correct answers such as, ‘as for black 1, A is superior. Nevertheless, while black 1 could be ignored, black 5 could also be considered a problem. With this, the descent of the black triangle is weakened. As for black 5, black 1 and 3 of the right diagram force white to live and should have come before black 7. In this case, in the same manner as in actual practice, black a, white b and black c also live,’ etc., are displayed in speech sound and/or letters and the learner can quickly comprehend this and this, further, helps in the raising of rank.

### Embodiment 7

As for an embodiment of an activity in the daily environment, the example of the treatment of ‘lower back pain’ is given. That is to say, as for the main heading section of the basic case of this field there are the seven items of, the structure of the lower back and the causes of lower back pain, diagnosis of lower back pain, treatment methods according to type of pain, illnesses that cause lower back pain, occupations that frequently experience lower back pain and appropriate countermeasures, points to consider in the treatment of lower back pain, and when surgery becomes necessary.

And, as for the subheading section, for structure of the lower back and the causes of lower back pain there are, maintaining posture and balance, spine and vertebrae and intervertebral discs, central nervous system, muscles for balanced support, causes of leg pain accompanying lower back pain (disposition to sciatica), psychological influences, diagnosis of lower back pain, making the decision on whether or not to go to the hospital, go straight to the hospital in the case of dangerous lower back pain, diagnosis based on the presence, or lack thereof, of leg pain varies, acute lower back pain and chronic lower back pain, and grouping lower back pain types into <anteflexion type and retroflexion type>.

As for diagnosis of lower back pain the menus displayed are, what kind of hospital should I go to for a diagnosis, how to effectively respond to the doctor's diagnostic questions, examination for lower back pain, diagnosis by imaging, being admitted to the hospital, ‘treatment methods for lower back pain,’ anteflexion lower back pain, points to note concerning treatment methods, prevention of lower back pain, retroflexion lower back pain, herniated intervertebral disc, and lower back pain related to weakening of the bones and, as for concrete examples of treatments for lower back pain the menus displayed are, treatment example of acute lower back pain (strained back), treatment example of heteromorphic lumbar vertebrae, treatment example of lumbar vertebrae herniated intervertebral disc, treatment example of lumbar region spinal canal stenosis, treatment example of slippage due to degenerate lumbar vertebrae, treatment example of lumbar vertebrae separation•lumbar vertebrae separation slippage, treatment example of spinal column•spinal cord tumors, treatment example of inflammation of the spinal column, and treatment example of osteoporosis.

Occupations that frequently experience lower back pain and appropriate countermeasures is also an important item. Here, as for the subheading the displayed items are, lower back pain of office workers, lower back pain of homemakers, lower back pain of drivers, lower back pain of pregnant women and of women who have given birth (after giving birth), etc., common lower back pain of sports participants, lower back pain of agricultural workers•animal husbandry workers, lower back pain of workers doing heavy labor and of workers who labor in cold locations, etc., and lower back pain of health care workers (doctors•nurses, etc.).

As for ‘points for curing lower back pain in daily life’ the menus displayed are, points in daily life, points to remember concerning the posture of sitting in chairs, on the floor, etc., points to remember concerning standing posture and walking posture, points to remember concerning posture•movements at the wash basin, when taking a bath, etc., points to remember when getting up and going to bed for those with lower back pain, and carry your baby on your back as much as possible and, as for ‘when surgery is required,’ surgery method for lumbar vertebrae herniated intervertebral disc, surgery for lumbar region spinal canal stenosis, surgery for lumbar vertebrae slippage, are displayed.

Presently, an office worker is suffering from lower back pain. Here, when lower back pain of office workers is clicked a graphic representation as in FIG. 13 is displayed and the question, ‘When working are you in this posture?’ is asked. Again, that is to say, on the left side of the same diagram, ‘In the case of a seat with a back use a roll-shaped cushion, personal backrest, waist pouch, etc., in order to maintain the physiological curvature of your lower back.,’ is produced in speech sound, etc., and, if necessary, in letters and, subsequently, writing such as, ‘You can use a pad for your lower back. The pad is positioned, in this way, at a position slightly lower than the level of the navel (at the level of third lumbar vertebra and the fourth lumbar vertebra) and, then, when sitting so that the rump bone (sacrum) makes contact with the back support, it becomes easy to maintain the forward curvature of the lumbar vertebrae.,’ etc., may be displayed.

Furthermore, appropriate advice is given such as, ‘You may also sit using a sitting board. When this is done, due of the angle, the pelvis is angled slightly forward and the lumbar region takes on the same forward curvature as at the time when walking and the load on the lower back, particularly the intervertebral discs, is reduced. Moreover, a pillow, cushion, etc., is placed on the floor and the back of one knee is laid on that. By doing so, the knee area of that leg takes on a right angle curve and that leg can support one half of the body's weight. Then, one sits down on the front part of the seat and sits forward in the seat. Further, this method can be used in a chair without a back as is shown in the right side of the diagram. The posture of this diagram is the worst but if, consciously, the back and the stomach are tightened by using the spine and the abdominal muscles, the forward curvature of the lower back can be maintained. Furthermore, it is frequently the case that the distance between the surface of a normal desk and the eyes is too great and if the height of the desk is raised slightly, etc., or if the desk is angled then that will make it easier to work.,’ etc.

### Effects

Generally speaking, the effects of the present invention are:

(1) It is made possible wherein, there is a main heading section of a plurality of basic performances (problem points) that learners want to know about and, by clicking these basic examples of problem points, the method for improvement is instantly displayed by a graphic representation and/or letters and speech sound, and the proper guidance can be given to the learners.

(2) It is made possible wherein, the data of the above described examples of problem points, as well as their method of improvement, are such that can be searched, edited, processed through operations and recorded, by means of electronic apparatuses such as DVD, the Internet, personal computer, etc., and by using such the learner can click the example of the problem point for instant display.

(3) Moreover, it is made possible wherein, as for the form that is displayed of the method of improvement of the above described examples of problem points, when the learner looks at the images which make up the criteria the lines and grid lines there is no overlapping display and, thus, the portion of the performance showing the proper point is displayed and the learner is made to understand the proper ‘form’ of the performance.

(4) It is made possible wherein, the above described proper performance of the instructor and the poor performance that the learner is prone to are displayed without overlapping and, by comparing and contrasting the various differences therein, the learner can be made to understand the differences in the performances.

(5) It is made possible wherein, the learner is taught by the above described images, being still images and/or moving images, and the proper performance can be taught, together with movements, so that the level of understanding of the learner can is raised.

(6) It is made possible wherein, furthermore, the performance of the above described instructor and/or learner can be preserved on a hard copy (paper), FD (floppy disc), CD (compact disc), DVD (digital versatile disc), or other recording medium and, wherein, whenever necessary this can be accessed.

(7) It is made possible wherein, as for individual sports, as represented by golf, tennis etc., team sports, as represented by baseball, soccer etc., combative sports, as represented by judo, wrestling, etc., outdoor sports, as represented by skiing, swimming, etc., sports where an object is pursued, as represented by fishing, hunting, etc., hobby games, such as go, chess etc., amusements, various types of medical treatments, beauty treatments, etc., as representative of activities in the daily environment, an instructor can give guidance to a learner as to proper performance.

### BRIEF DESCRIPTION OF THE DRAWINGS

FIG. 1 is a block diagram showing the apparatus used in the present invention;

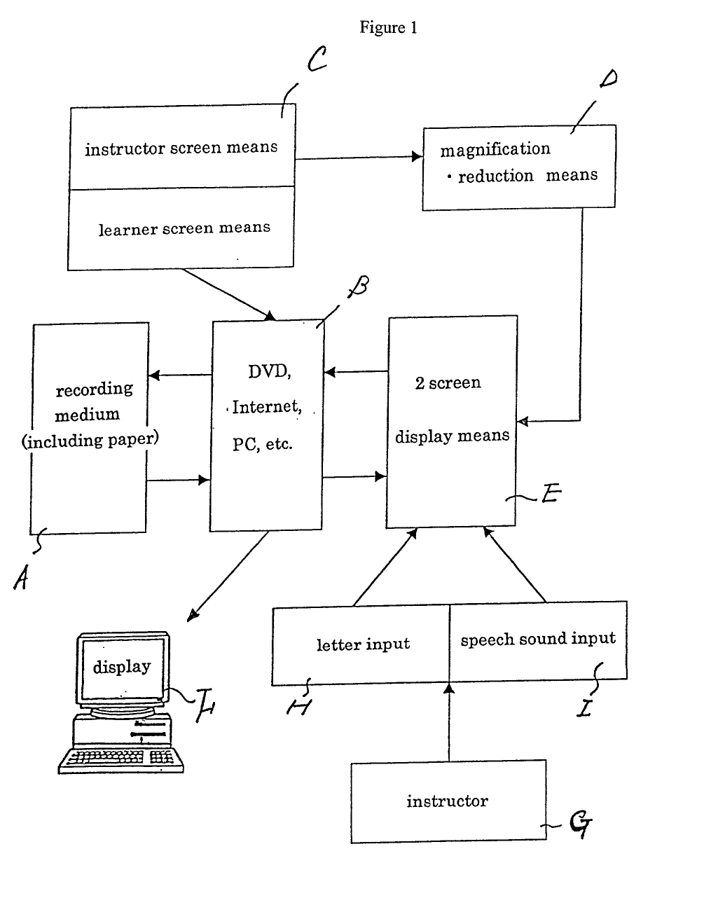

FIG. 2 is a block diagram for the purpose of explaining the heading section and subheading section and other menus used to give guidance concerning golf, as an embodiment of an individual sport of the present invention;

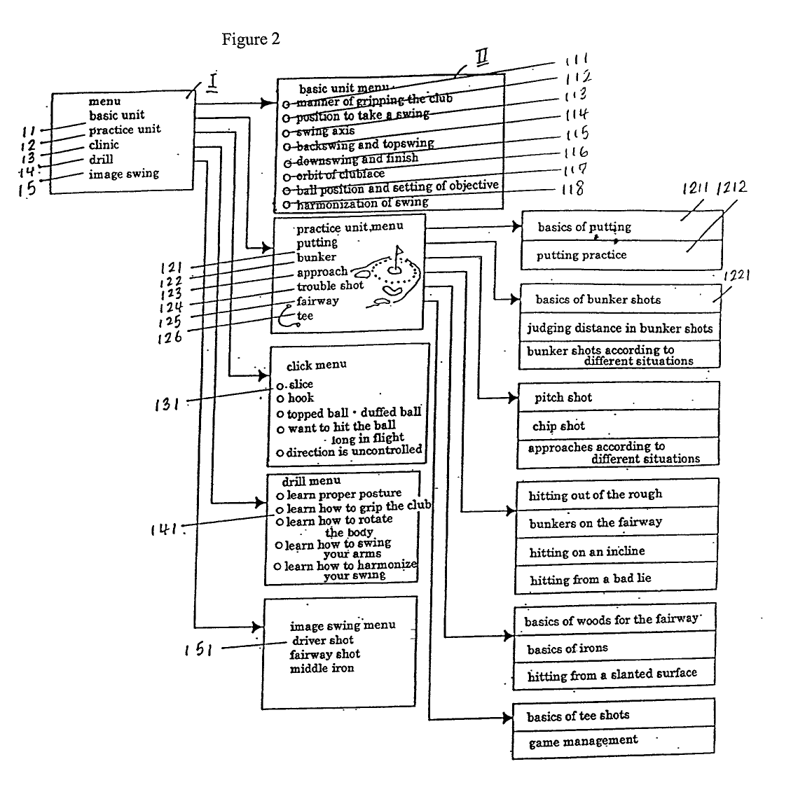

FIG. 3 is an explanatory diagram wherein are shown the grip of the same instructor, in particular the lines basic to gripping;

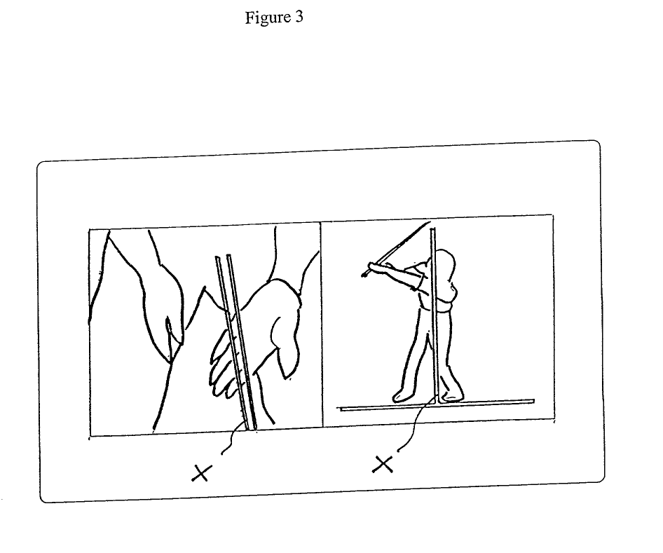

FIG. 4 is an explanatory diagram wherein the form that the learner is prone to, as seen by the same instructor, is displayed on two screens without overlapping;

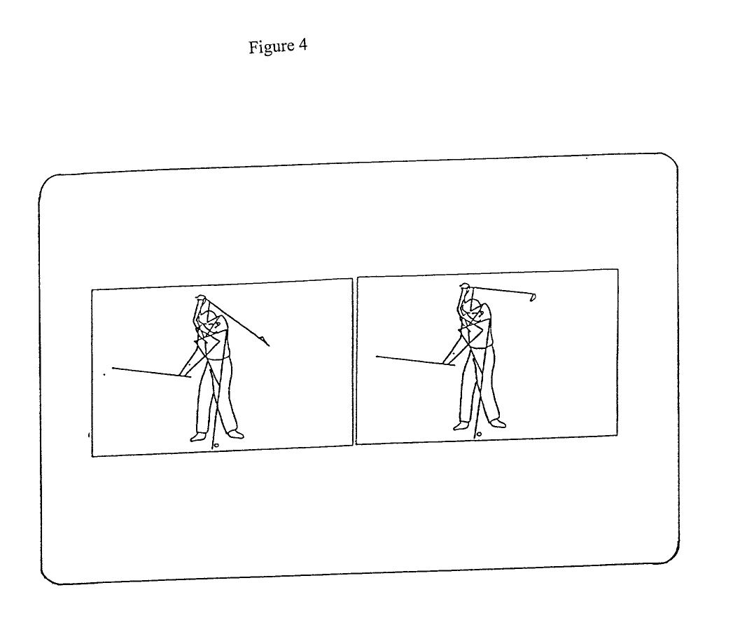

FIG. 5 is a flow chart showing the proper steps for guidance based on examples of problem points that are easy to fall into;

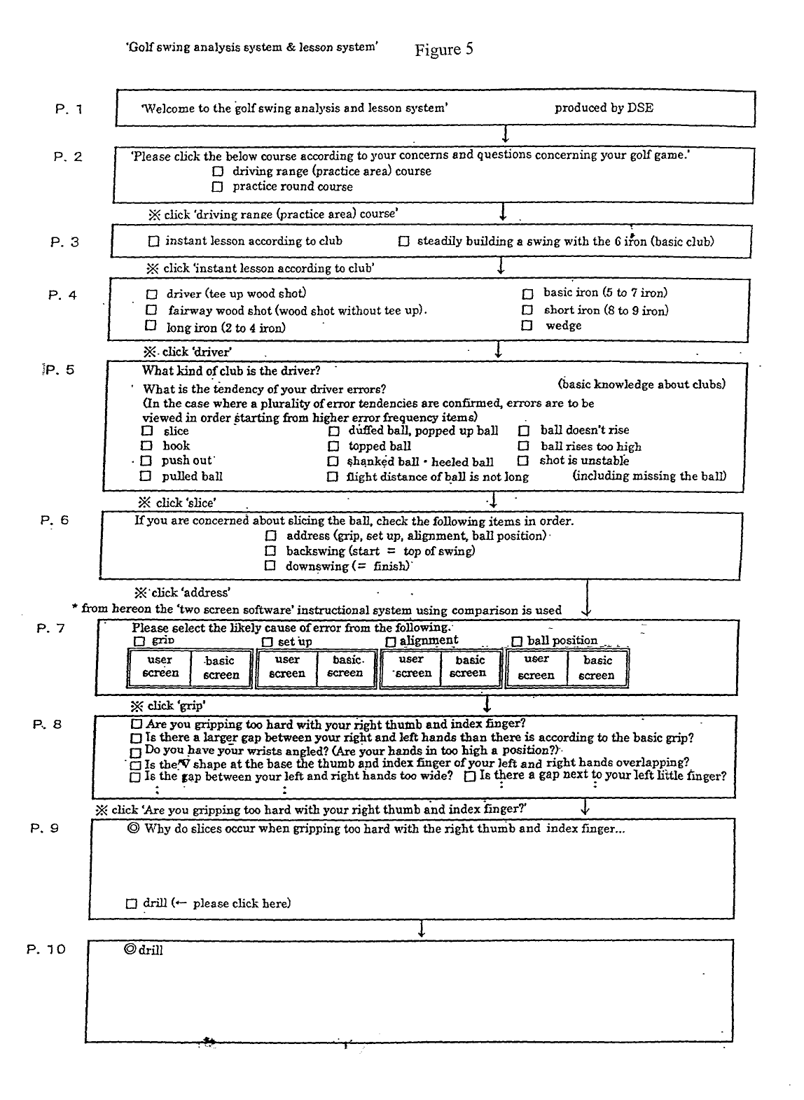

FIG. 6 is a block diagram for the purpose of explaining the heading section and subheading section and other menus used to give guidance concerning baseball, as an embodiment of a team sport of the present invention;

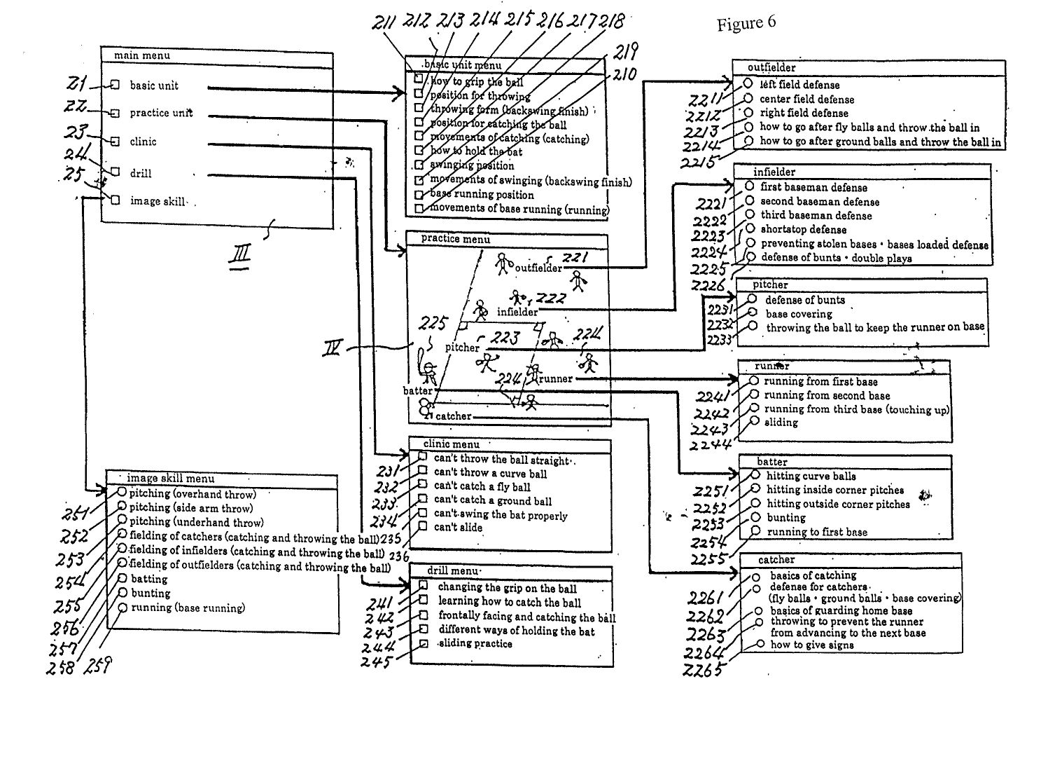

FIG. 7 is an explanatory diagram wherein the hitting form that the learner is prone to, as seen by the same instructor, is displayed on two screens without overlapping;

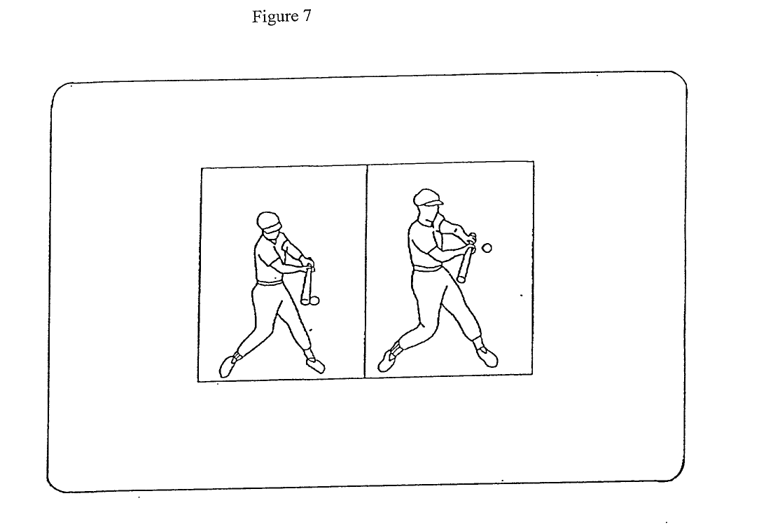

FIG. 8 is a block diagram for the purpose of explaining the heading section and subheading section and other menus used to give guidance concerning judo, as an embodiment of a combative sport of the present invention;

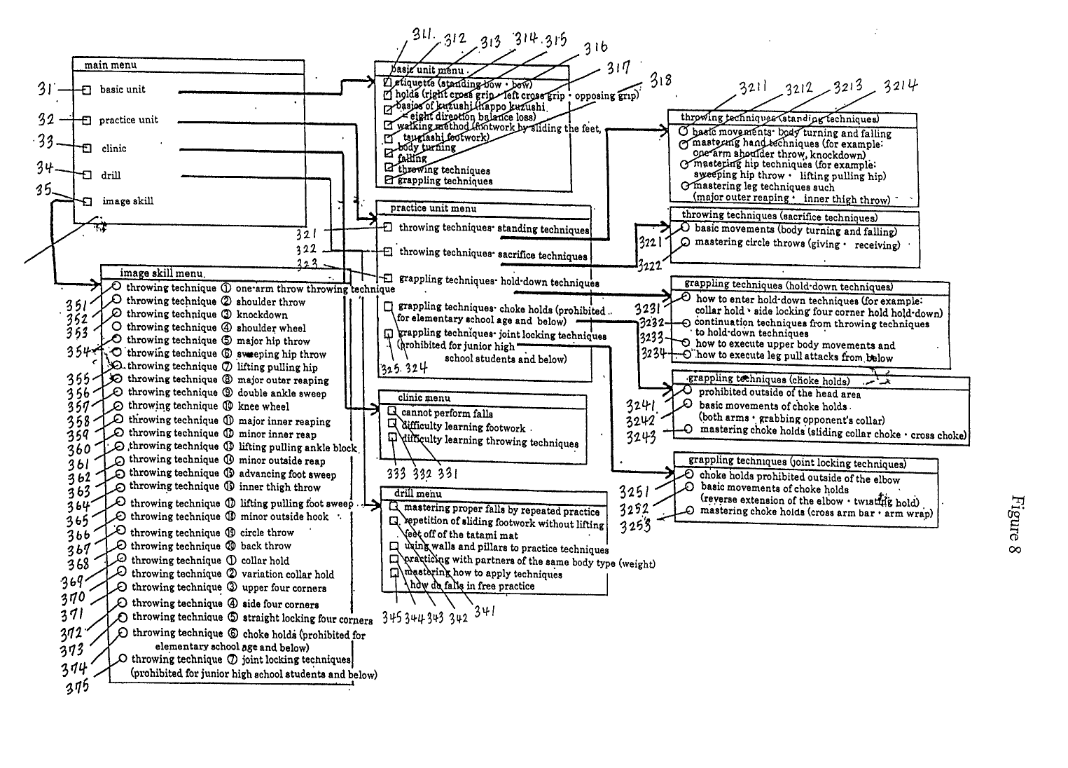

FIG. 9 is an explanatory diagram wherein the body turning form that the learner is prone to, as seen by the same instructor, is displayed on two screens without overlapping;

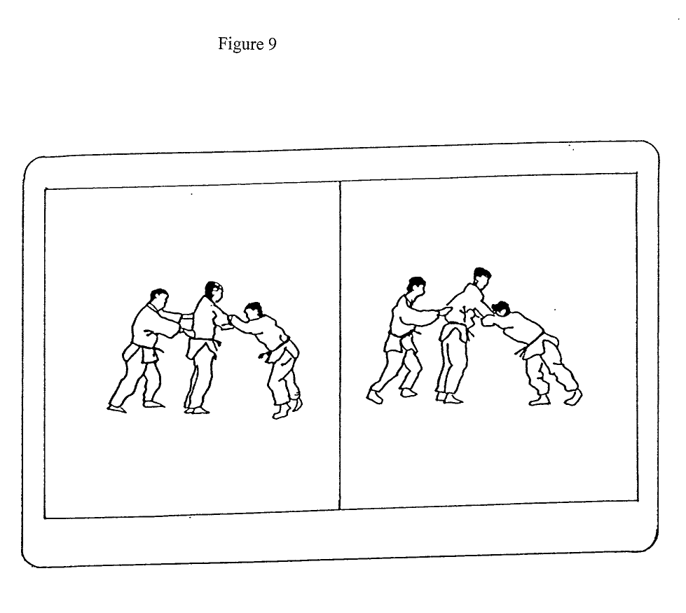

FIG. 10 is an explanatory diagram of guidance in skiing, as an embodiment of an outdoor sport of the present invention, wherein the form that the learner is prone to, as seen by the same instructor, is displayed on two screens without overlapping;

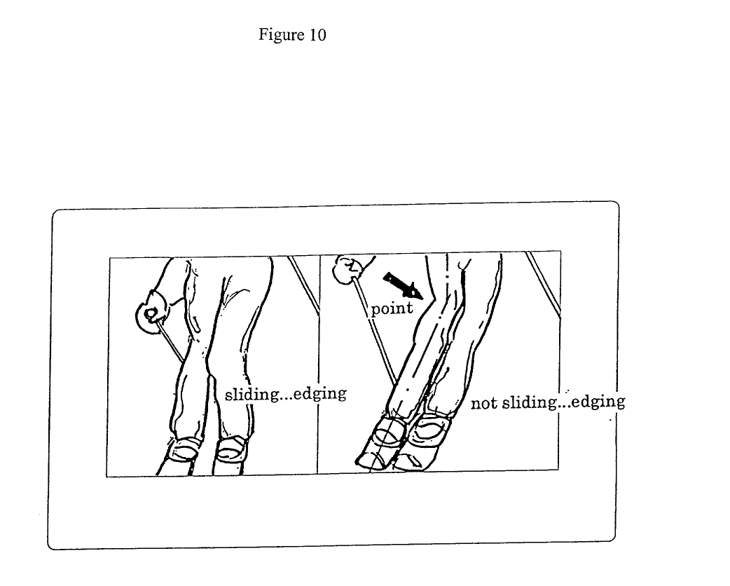

FIG. 11 is a explanatory diagram of guidance in fishing, as an embodiment of an amusement of the present invention, wherein the form that the learner is prone to, as seen by the same instructor, is displayed on two screens without overlapping;

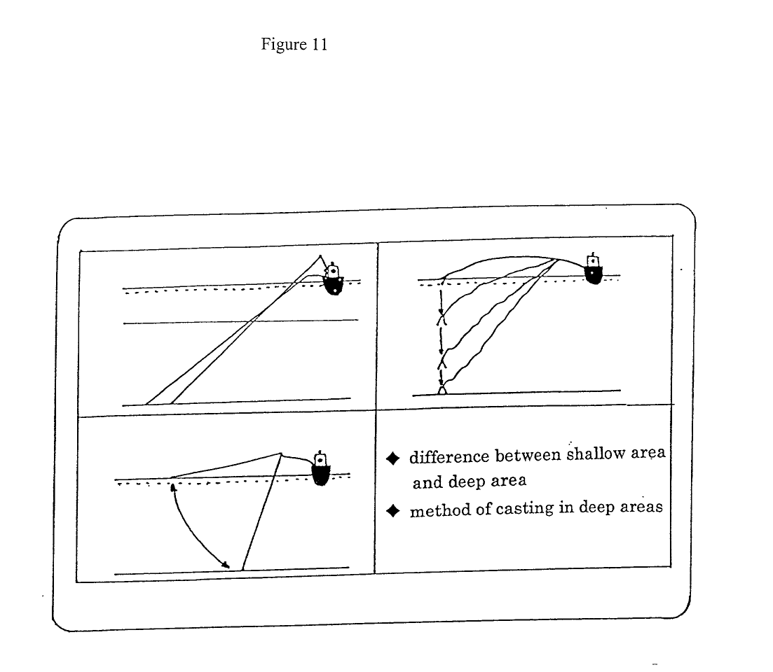

FIG. 12 is a explanatory diagram of guidance in go, as an embodiment of an amusement of the present invention, wherein the form that the learner is prone to, as seen by the same instructor, is displayed on two screens without overlapping;

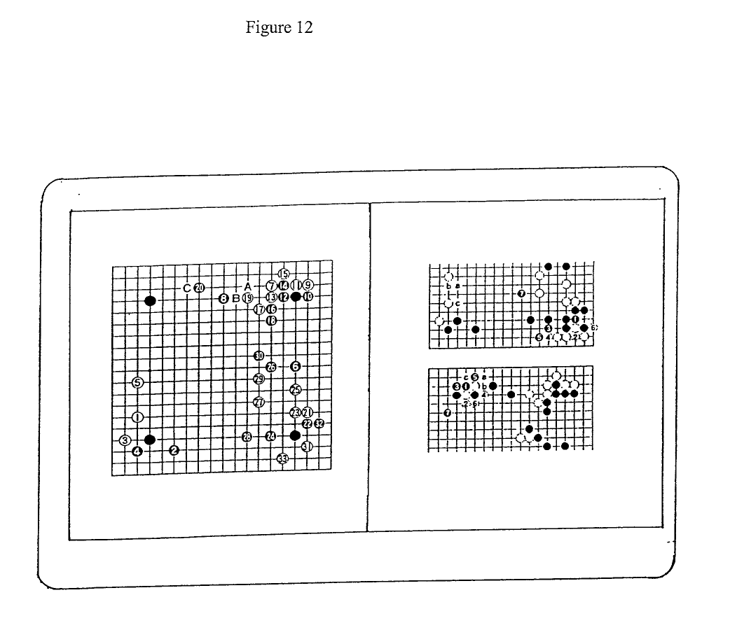

FIG. 13 is a explanatory diagram of guidance in treatment of lower back pain, as an embodiment of an activity in the daily environment of the present invention, wherein the form that the learner is prone to, as seen by the same instructor, is displayed on two screens without overlapping.

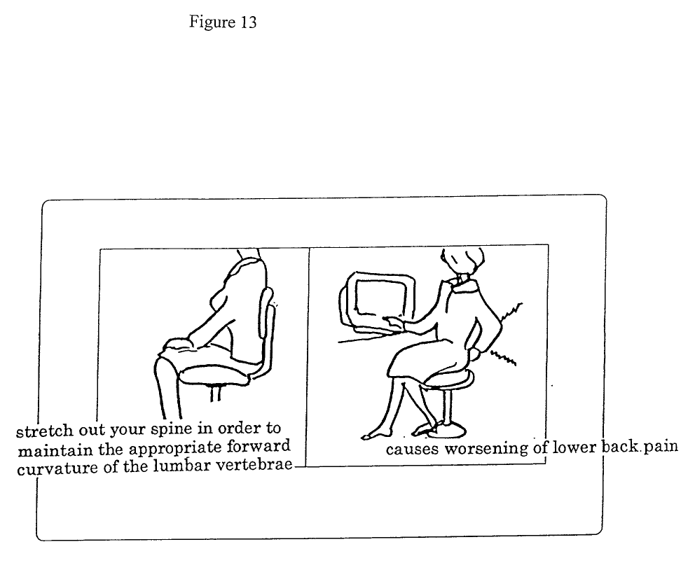

What is claimed is:

1. An instructional method for sports, hobbies, amusements and for other activities in the daily environment, etc., comprising:
a main heading section of a plurality of basic examples of problem points;
a concrete subheading menu which is displayed by clicking these basic examples of problem points; and
an electronic apparatus means by which the improved performance of an instructor can be recorded, edited and searched, wherein
by clicking the above described main heading section and subheading section, concrete examples of problem points and methods for overcoming those problems are presented in images, and displayed as diagrammatic representation and/or letters, speech sound, or the like.

2. An instructional method for sports, hobbies, amusements and for other activities in the daily environment, etc., according to claim 1, characterized in utilizing a DVD (digital video disc) system as a means of recording, editing, processing through operations and searching the data of the said examples of individual problem points as well as methods for improvement.

3. An instructional method for sports, hobbies, amusements and for other activities in the daily environment, etc., according to claim 1, characterized in utilizing an Internet system, as a means of recording, editing, processing through operations and searching the data of the said examples of individual problem points as well as methods for improvement.

4. An instructional method for sports, hobbies, amusements and for other activities in the daily environment, etc., according to claim 1, characterized in utilizing a computer system, as a means of recording, editing, processing through operations and searching the data of the said examples of individual problem points as well as methods for improvement.

5. An instructional method for sports, hobbies, amusements and for other activities in the daily environment, etc., according to claim 1, characterized in that, as for the images of methods of improvement shown in the said claim 1, when the learner looks at the display of the overlapping lines or grid lines on those images, which make up the criteria, the learner can be made to understand the proper method for improvement.

6. An instructional method for sports, hobbies, amusements and for other activities in the daily environment, etc., according to claim 2, characterized in that, as for the images of methods of improvement shown in the said claim 1, when the learner looks at the display of the overlapping lines or grid lines on those images, which make up the criteria, the learner can be made to understand the proper method for improvement.

7. An instructional method for sports, hobbies, amusements and for other activities in the daily environment, etc., according to claim 3, characterized in that, as for the images of methods of improvement shown in the said claim 1, when the learner looks at the display of the overlapping lines or grid lines on those images, which make up the criteria, the learner can be made to understand the proper method for improvement.

8. An instructional method for sports, hobbies, amusements and for other activities in the daily environment, etc., according to claim 4, characterized in that, as for the images of methods of improvement shown in the said claim 1, when the learner looks at the display of the overlapping lines or grid lines on those images, which make up the criteria, the learner can be made to understand the proper method for improvement.

9. An instructional method for sports, hobbies, amusements and for other activities in the daily environment, etc., according to claim 3, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

10. An instructional method for sports, hobbies, amusements and for other activities in the daily environment, etc., according to claim 2, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

11. An instructional method for sports, hobbies, amusements and for other activities in the daily environment, etc., according to claim 3, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

12. An instructional method for sports, hobbies, amusements and for other activities in the daily environment, etc., according to claim 4, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

13. An instructional method for sports, hobbies, amusements and for other activities in the daily environment, etc., according to claim 5, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

14. An instructional method for sports, hobbies, amusements and for other activities in the daily environment, etc., according to claim 6, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

15. An instructional method for sports, hobbies, amusements and for other activities in the daily environment, etc., according to claim 7, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

16. An instructional method for sports, hobbies, amusements and for other activities in the daily environment, etc., according to claim 8, characterized in that the plurality of images of the examples of problem points in the methods of improvement, the methods of improvement, or the like, as shown in claim 1, are displayed, respectively, without overlap and by comparing and contrasting the differences in the respective images the learner can be made to understand thereof.

17. An instructional method for sports, hobbies, amusements and for other activities in the daily environment, etc., according to claims 1 to 16, characterized in having, as for the images shown in said claim 5, still images and/or moving images.

18. An instructional method for sports, hobbies, amusements and for other activities in the daily environment, etc., according to claims 1 to 17, characterized in being able to be recorded, as shown in said claim 6, on a recording medium, including paper and, by serving as a reference, later enabling the learner to understand his improvement.

19. An instructional method for sports, hobbies, amusements and for other activities in the daily environment, etc., according to claims 1 to 18, characterized in that problem examples, as shown in said claim 1, are of an individual sport, as represented by golf, fishing, tennis, table tennis, or the like.

20. An instructional method for sports, hobbies, amusements and for other activities in the daily environment, etc., according to claims 1 to 19, characterized in that problem examples, as shown in said claim 1, are of a team sport, as represented by baseball, soccer, basketball, or the like.

21. An instructional method for sports, hobbies, amusements and for other activities in the daily environment, etc., according to claims 1 to 20, characterized in that problem examples, as shown in said claim 1, are of a combative sport, as represented by sumo, wrestling, judo, boxing, or the like.

22. An instructional method for sports, hobbies, amusements and for other activities in the daily environment, etc., according to claims 1 to 21, characterized in that problem examples, as shown in said claim 1, are of an outdoor sport, as represented by surfing, skiing, skating, swimming, or the like.

23. An instructional method for sports, hobbies, amusements and for other activities in the daily environment, etc., according to claims 1 to 22, characterized in that problem examples, as shown in said claim 1, are of sports where an object is pursued, as represented by fishing, hunting, or the like.

24. An instructional method for sports, hobbies, amusements and for other activities in the daily environment, etc., according to claims 1 to 23, characterized in that problem examples, as shown in said claim 1, are of hobby games and amusements, as represented by go, chess, shogi, dance, billiards, or the like.

25. An instructional method for sports, hobbies, amusements and for other activities in the daily environment, etc., according to claims 1 to 24, characterized in that problem examples, as shown in said claim 1, are of activities in the daily environment, as represented by various types of medical treatments, beauty treatments, weight training, flower arrangement, floral art, cooking, or the like.
